(19) United States
(12) Patent Application Publication
(10) Pub. No.: US 2022/0025100 A1
(43) Pub. Date: Jan. 27, 2022

(54) THERMOLATENT CATALYST FOR POLYMERIZATION OF ISOCYANATES

(71) Applicant: Covestro Intellectual Property GmbH & Co. KG, Leverkusen (DE)

(72) Inventors: Yan Deng, Shanghai (CN); Heiko Hocke, Leverkusen (DE); Dongbo Zhao, Shanghai (CN); Ruqi Chen, Shanghai (CN)

(21) Appl. No.: 17/311,729

(22) PCT Filed: Dec. 12, 2019
(86) PCT No.: PCT/EP2019/084783

§ 371 Date: Jun. 8, 2021

(30) Foreign Application Priority Data
Dec. 19, 2018 (CN) PCT/CN2018/121966
Jan. 10, 2019 (EP) 19151199.7

(51) Int. Cl. C08G 18/22; B01J 31/04; C08G 18/09; C08G 18/02; B01J 35/02

(52) U.S. Cl. CPC C08G 18/225; B01J 31/04; B01J 2531/13; C08G 18/022; B01J 35/023; C08G 18/092

(57) ABSTRACT

The present invention relates to novel thermolatent catalysts for the manufacture of isocyanurate and polyisocyanate polymers.

The present invention relates to novel thermolatent catalysts for the manufacture of isocyanurate and polyisocyanate polymers.

Polyisocyanurate plastics and the use of potassium acetate as catalyst in their production are known, e.g., from WO 2016/170059. Composite materials with a polyisocyanurate matrix have been disclosed in WO 2017/191216. The pot life of the polymerizable composition was in the range of five hours at a temperature of 23° C.

However, it turned out that the combination potassium acetate with polyethylene glycol as catalyst has a low pot life at temperatures of 50° C., particularly if the air moisture is high. Such conditions are frequently encountered in workshops in tropical climates. Under these conditions the viscosity of the reaction mixture may increase by a factor of 10 or more after only one hour. Moreover, foam formation on the surface of the reaction mixture is a frequent problem. These effects combined render such a reaction mixture impractical for any application, in particular the impregnation of fibers in an open bath for pultrusion or filament winding processes. Hence, there was a high need for alternative trimerization catalysts which allow the preparation of reaction mixtures with increased pot life under tropical conditions.

One well known technique for producing latent catalysts is the encapsulation of a liquid catalyst in a solid shell in order to isolate it from the reactants. For trimerization catalysts based on alkali metal salts this has been disclosed in U.S. Pat. No. 3,860,565. The encapsulated catalyst can easily be activated by exposure to various kinds of energy (radiation, heat, mechanical forces) which may result in an unwanted activation during the preparation of the catalyst or processing of the reactive composition.

Therefore, the problem underlying the present invention is the provision of a non-encapsulated catalyst for the crosslinking of isocyanate groups with a long pot life at temperatures up to 50° C. and a high reactivity above that temperature. Said catalyst should not be hygroscopic and should not promote foaming of an isocyanate composition. Furthermore, the catalyst should be easily obtained and readily be used without sophisticated processing to ensure broad industrial use. The problem is solved by the embodiments defined by the claims and in this description below.

In the study underlying the present invention it was surprisingly found that a catalyst does not need to be encapsulated in order to sufficiently decrease its activity. It is completely sufficient to formulate it as a solid material with a low surface-to-weight ratio in order to decrease the interaction between catalyst and reaction partners. If a material is chosen which melts or dissolves above the typical ambient temperatures and becomes by doing so fully accessible, the catalyst's activity may simply be triggered by heating it to a point, where it changes its state of matter either by melting or by dissolving in a suitable solvent.

Hence, in a first embodiment, the present invention relates to a method for producing a polymer comprising the steps of
a) providing a polymerizable composition comprising
   (i) a liquid phase comprising at least one polyisocyanate,
   (ii) a solid phase comprising at least one catalyst comprising a metal salt having a carboxylate or a phenolate as the anion capable of crosslinking the polyisocyanate so that a polymer is formed, wherein said catalyst is solid below a temperature of 50° C. and is liquid or dissolved at the polymerization temperature of 60° C. to 280° C., and
b) heating the polymerizable composition to the polymerization temperature and maintaining said temperature at least until the polymerizable composition reaches the gel point.

The gel point is defined as the point when storage modulus and loss modulus have the same value, i.e. tan δ is 1. The values can be determined easily by rheological measurements.

Polymerizable Composition

The term “polymerizable composition” refers to a mixture of components which forms a polymer if heated to the polymerization temperature. The resulting polymer is, preferably, solid at a temperature of 50° C. The polymerizable composition of the present invention is a suspension of solid catalyst particles in a liquid phase, wherein the liquid phase comprises at least one polyisocyanate. Depending on the type of crosslinking reaction it may be necessary that the polymerizable composition comprises at least two types of reactants. If, for example, the formation of a polyurethane is intended, the polymerizable composition must comprise at least two types of reactants, at least one polyisocyanate and at least one polyol.

The term “providing a polymerizable composition” refers to a process which results in the above-described suspension. Preferably, the catalyst particles are distributed evenly within the liquid phase.

In principle, all methods which result in such a suspension are equally suitable. However, according to the present invention, there are preferred embodiments.

In one preferred embodiment of the present invention, the at least one catalyst is present in form of particles with properties as defined further below in this application. Said particles are then simply added to a liquid comprising at least one polyisocyanate. This embodiment only requires a mechanical mixing process. The particular means and methods for the mixing process depend on the rheological properties of the catalyst particles and the liquid phase comprising the polyisocyanate.

In another preferred embodiment of the present invention, the catalyst comprising a metal salt having a carboxylate or a phenolate as the anion additionally comprises a liquid which acts as carrier or co-catalyst and is not a polyisocyanate. The term “co-catalyst” refers to a compound which increases the catalytic activity of the metal salt. The catalyst is present in form of particles with properties as defined further below in this application. Said particles are then simply added to the liquid acting as carrier or co-catalyst and finely dispersed in it. This pre-dispersed catalyst mixture may be used as masterbatch and diluted into the liquid phase comprising at least one polyisocyanate, thus forming the polymerizable composition. This embodiment only requires a mechanical mixing process. The particular means and methods for the mixing process depend on the rheological properties of the catalyst particles and the liquid phases. The liquid acting as carrier or co-catalyst is preferably diethylene glycol or a polyethylene glycol derivative having at least three consecutive ethylene oxide units in the polymer molecule and is more preferably diethylene glycol or polyethylene glycol having a number average molecular weight between 100 g/mol and 600 g/mol. Preferably, at handling temperature as defined further below in this application the catalyst is insoluble in the liquid carrier. The catalyst is insoluble in the carrier if its solubility at handling temperature does not exceed 10.0 g/l and more preferably 1.0 g/l.

The person skilled in the art is easily able to select suitable means and process parameters based on his general knowledge.

In another preferred embodiment, the catalyst is added in liquid form to the liquid phase. The resulting mixture is then cooled to a temperature which is low enough for the catalyst to precipitate or solidify so that the polymerizable composition of the present invention is obtained from a solution or a mixture of at least two liquids. This method is particularly advantageous for catalysts which require high temperatures for their activity so that there is a temperature range, where the catalyst is already molten or dissolved but not yet active. Then, the polymerizable composition can be prepared at a temperature within this “safe” range without a significant degree of catalyst activity.

The term “solid phase” refers to all solid materials present in the polymerizable composition. It comprises at least one catalyst capable of crosslinking the polymerizable reactants. If more than one catalyst is present in the polymerizable composition, it is preferred that all catalysts are present in solid form unless there is a synergistic relationship between different catalyst so that a liquid catalyst requires a solid component for its activity.

However, the solid phase may additionally comprise components which are not catalysts. Such components are, for example, organic or inorganic fillers or organic or inorganic pigments. While an even curing process requires that at least one catalyst—and preferably all catalysts present in the composition—capable of crosslinking the polymerizable reactants is/are evenly distributed within the solid phase at the beginning of method step b), other components may have an uneven distribution. It is, for example possible—and in some instances even desirable—to have a high concentration of pigments on the surface of the reaction mixture and a lower concentration in its core.

Liquid Phase

The liquid phase of the polymerizable composition comprises at least one polyisocyanate. In principle, said polyisocyanate may be dissolved in a suitable solvent or in another reactant. However, if the polymerizable composition is intended for the production of shaped bodies, it is preferred to minimize the content of solvents. In the most preferred embodiment no solvent is used. Therefore, it is preferred that the at least one polyisocyanate is liquid or—if a mixture of polymerizable reactants is used—the whole mixture is liquid. Any component which becomes part of the polymer network, i.e. any reactive solvent, or remains mostly, i.e. to more than 50 wt.-%, of its original mass, in the cured product (e.g. release agents, impact or flame retardant modifiers) is not a “solvent” as understood by the present application.

Polyisocyanate

The term “polyisocyanate” as used here is a collective term for compounds containing two or more isocyanate groups in the molecule (this is understood by the person skilled in the art to mean free isocyanate groups of the general structure —N═C═O). The simplest and most important representatives of these polyisocyanates are the diisocyanates. These have the general structure O═C═N—R—N═C═O where R typically represents aliphatic, alicyclic and/or aromatic radicals.

Because of the polyfunctionality 2 isocyanate groups), it is possible to use polyisocyanates to prepare a multitude of polymers (e.g. polyurethanes, polyureas and polyisocyanurates) and low molecular weight compounds (for example urethane prepolymers or those having uretdione, isocyanurate, allophanate, biuret, iminooxadiazinedione and/or oxadiazinetrione structure).

When general reference is made here to “polyisocyanates”, this means monomeric and/or oligomeric polyisocyanates. For understanding of many aspects of the invention, however, it is important to distinguish between monomeric diisocyanates and oligomeric polyisocyanates. When reference is made here to “oligomeric polyisocyanates”, this means polyisocyanates formed from at least two monomeric diisocyanate molecules, i.e. compounds that constitute or contain a reaction product formed from at least two monomeric diisocyanate molecules.

For example, hexamethylene diisocyanate (HDI) is a “monomeric diisocyanate” since it contains two isocyanate groups and is not a reaction product of at least two polyisocyanate molecules:

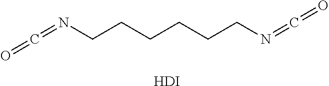

Reaction products which are formed from at least two HDI molecules and still have at least two isocyanate groups, by contrast, are “oligomeric polyisocyanates” within the context of the invention. Representatives of such “oligomeric polyisocyanates” are, proceeding from monomeric HDI, for example, HDI isocyanurate and HDI biuret, each of which are formed from three monomeric HDI units:

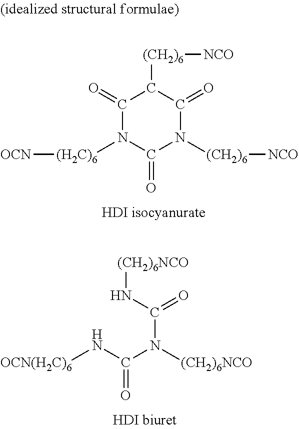

The oligomeric polyisocyanates may, in accordance with the invention, especially have uretdione, urethane, isocyanurate, allophanate, biuret, iminooxadiazinedione and/or oxadiazinetrione structure. In one embodiment of the invention, the oligomeric polyisocyanates have at least one of the following oligomeric structure types or mixtures thereof:

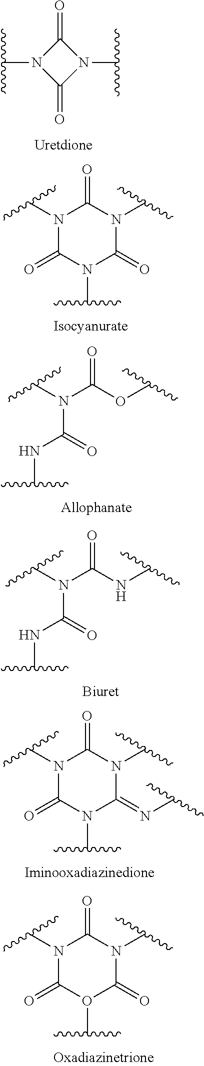

In a preferred embodiment of the present invention, the liquid phase comprises at least one oligomeric polyisocyanate having an isocyanurate structure.

Suitable monomeric polyisocyanates which may be present in the liquid phase as such or which may be used as starting material for the production of the above-defined oligomeric polyisocyanates are selected from the group consisting of aliphatic, cycloaliphatic, araliphatic and aromatic polyisocyanates.

In one preferred embodiment of the present invention, the reaction mixture comprises up to 60 wt.-%, more preferably up to 40 wt.-% and most preferably up to 20 wt.-% of aromatic polyisocyanates.

However, it is particularly preferred that monomeric and/or oligomeric aliphatic polyisocyanates make up at least 90 wt.-% of all polyisocyanates comprised in the polymerizable composition. It is particularly preferred that oligomeric aliphatic polyisocyanates make up at least 90 wt.-% of all polyisocyanates comprised in the polymerizable composition

The term “aliphatic polyisocyanate” refers to all isocyanates having isocyanate groups which are directly bound to a carbon atom which is part of an open chain of carbon atoms.

Preferred aliphatic polyisocyanates are butyldiisocyanate and all isomers thereof, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane and 1,10-diisocyanatodecane. Particularly preferred are HDI and PDI.

The term “cycloaliphatic polyisocyanate” refers to all isocyanates having isocyanate groups which are directly bound to a carbon atom which is part of a ring structure, provided that said ring structure is not aromatic.

Preferred cycloaliphatic polyisocyanates are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethyl-cyclohexane (IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis-(isocyanatomethyl)-norbornane (NBDI), 4,4′-diisocyanato-3,3′-dimethyldicyclohexylmethane, 4,4′-diisocyanato-3,3′,5,5′-tetramethyl-dicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetra-methyl-1,1′-bi(cyclohexyl), 1,8-diisocyanato-p-menthane, 1,3-diisocyanato-adamantane and 1,3-dimethyl-5,7-diisocyanatoadamantane. Particularly preferred is IPDI.

The term “aromatic polyisocyanate” refers to all isocyanates having isocyanate groups which are directly bound to an aromatic ring.

Preferred aromatic polyisocyanates are 2,4- and 2,6-toluene diisocyanate (TDI), 2,4′- and 4,4′-methylene diphenyl diisocyanate (MDI), polymeric 2,4′- and 4,4′-methylene diphenyl diisocyanate (pMDI and 1,5-naphthyl diisocyanate.

The term “araliphatic polyisocyanate” refers to all isocyanates having isocyanate groups which are bound to a methylene group which is in turn is bound to an aromatic ring.

Preferred araliphatic polyisocyanates are 1,3- and 1,4-bis-(isocyanatomethyl)benzene (xylylene diisocyanate; XDI), 1,3- and 1,4-bis(1-isocyanato-1-methyl-ethyl)-benzene (TMXDI) and bis(4-(1-isocyanato-1-methylethyl)phenyl)-carbonate.

Component Reactive with Isocyanate

A “component reactive with isocyanate” is any component having at least one functional group, preferably on average at least two functional groups, per molecule which can react with isocyanate groups. Such functional groups are, preferably, hydroxyl groups, amino groups and thiol groups. Suitable as “component reactive with isocyanate” is any compound which is liquid above 20° C. or can be dissolved in the polyisocyanate.

Most preferably, the “component reactive with isocyanate” is a polyol having an average functionality of at least two hydroxyl groups per molecule. Preferred polyols have an OH-content of at least 25 wt.-%, more preferably at least 30 wt.-% and most preferably at least 35 wt.-%. The preferred maximum OH-content is 60 wt.-%. Particularly preferred polyols are 1,2,10-decanetriol, 1,2,8-octanetriol, 1,2,3-trihydroxybenzene, glycerol, 1,1,1-trimethylolpropane, 1,1,1-trimethylolethane, pentaerythritol and sugar alcohols.

In one preferred embodiment of the present invention the molar ratio of isocyanate groups to all functional groups reactive with isocyanate in the polymerizable composition is more than 3.0:1.0, preferably at least 5.0:1.0 and more preferably at least 10.0:1.0. In this embodiment the formation of the polymer network is predominantly mediated by the reaction of isocyanate groups with each other, while the formation of urethane groups, urea groups and thiourethane is only a side reaction.

In another preferred embodiment of the present invention a high content of urethane groups, urea groups and thiourethane groups in the polymer product is desired. In order to achieve this, the ratio of isocyanate groups to all functional groups reactive with isocyanate in the polymerizable composition is between 0.5:1.0 and 3.0:1.0, preferably between 0.5:1.0 and 2.0:1.0, more preferably between 0.8:1.0 and 1.5:1.0 and most preferably between 0.9:1.0 and 1.1:1.0.

In this embodiment it is preferred that hydroxyl groups make up at least 80 mol-% of all groups reactive with isocyanate in the polymerizable composition. It is particularly preferred that in this embodiment at least 80 mol-% of all groups reactive with isocyanate in the polymerizable composition belong to at least one polyol selected from the group consisting of 1,2,10-decanetriol, 1,2,8-octanetriol, 1,2,3-trihydroxybenzene, glycerol, 1,1,1-trimethylolpropane, 1,1,1-trimethylolethane, pentaerythritol and sugar alcohols

Catalyst

The catalyst is a metal salt having a carboxylate or phenolate as the anion. The metal is preferably selected from the group consisting of potassium, lithium, sodium, calcium, tin, magnesium and barium. More preferably, the metal is selected from the group consisting of potassium, lithium, sodium, calcium, magnesium and barium. The salt is solid at temperatures of up to 50° C. and liquid or dissolved in the liquid phase at the polymerization temperature.

Preferably, the anion is a carboxylate. The carboxylate is preferably the anion of an aliphatic carboxylic acid with at least 12 carbon atoms, more preferably with at least 14 or 16 carbon atoms, and most preferably with at least 18 carbon atoms in the molecule. Typical salts include laureate, myristate, palmitate, stearate or dimeric acids. Dimeric carboxylic acids can be obtained from aliphatic carboxylic acids having at least one double bond between two carbon atoms, e.g. oleic acid, by crosslinking the double bonds. However, any other carboxylate with a suitable melting or dissolution behavior is equally preferred. The aforementioned carboxylic acids may be used as pure compounds or as mixtures.

According to the present invention more preferred as catalytic active salts are potassium carboxylates. Most preferred is potassium stearate.

According to the present invention the transition of the metal salt from the solid to the liquid state can be effected by two mechanisms: melting and dissolution.

The term “melting” is well known to the person skilled in the art and refers to the process, wherein the intramolecular interactions in a material weaken due to increased temperature resulting in a phase transition from solid to liquid. The melting point can be characterized and observed by using analytical methods such as differential scanning calorimetry (DSC).

The term “dissolving” is also well known in the art. It refers to the process, wherein the metal salt dissolves in a suitable solvent. Said solvent is, preferably, liquid above 10° C., more preferably in the temperature range from 20° C. to 300° C. A suitable metal salt which is dissolved at the polymerization temperature is insoluble in the solvent at temperatures up to 50° C. and soluble at the polymerization temperature.

The person skilled in the art is aware that “solubility” and “insolubility” are in most cases not absolute terms. Even if a substance is considered as insoluble in a certain liquid, said liquid may comprise a very low concentration of dissolved molecules of said substance. Therefore, the difference between “insoluble” and “soluble” according to the present invention is preferably expressed in terms of a relative change of the solubility of a substance at different temperatures. A salt which can be used in the method according to the present invention increases its solubility in a particular liquid phase by a factor of at least 2, preferably least 5 and most preferably at least 10. The comparison is done at a “handling temperature” which is a defined temperature within the range between 10° C. and 50° C. and preferably between 15° C. and 30° C., and at polymerization temperature which is a defined temperature within the range between 60° C. and 280° C., provided that the temperature difference between both temperatures (handling and polymerization temperature) is at least 50° C., preferably 100° C. or more.

In a preferred embodiment of the present invention, a salt is defined as “insoluble” in the particular liquid phase if its solubility does not exceed 50.0 g/l, preferably 10.0 g/l and most preferably 1.0 g/l at “handling temperature”.

The particle size of the solid catalyst particles is important. If the particle size of the catalyst is too small, than the viscosity of the polymerizable composition will increase significantly and processing, e.g. flowability or wetting of fibers will be unacceptably decreased. If the particle size of the catalyst is too large, than the dispersion becomes instable and the particles sink to the bottom in a rather short period of time.

According to the invention, the number average particle size of the catalyst particles is between 100 nm (nanometer) and 100 μm (micrometer).

In a more preferred embodiment of the invention, the catalyst is formulated as particles with a number-average particle diameter of at least 100 nm, preferably at least 200 nm and most preferably at least 300 nm The number-average particle diameter should preferably not exceed 10 μm.

It is well understood that due to the mechanism of providing the active catalyst, an excess of catalyst particles may be applied as solid in the polymerizable composition at handling temperature, and only a part of this solid catalyst particles is later dissolved and actively participating in the polymerization. The remaining solid catalyst particles may function as filler in such case. The absolute concentration of the active catalyst is therefore defined as the concentration of dissolved catalyst at the polymerization temperature.

In a preferred embodiment of the present invention, the concentration of the active catalyst is at handling temperature insufficient to promote the polymerization of the polymerizable composition within 3 hours or less to a value of the viscosity 3 times higher than the starting viscosity of the polymerizable composition and preferably to the gel point, and upon heating to polymerization temperature increases to a level of concentration to promote the polymerization process to the gel point within 20 min or less.

It has been found that the use of the catalysts of the present invention is also suitable for creating a latent reaction mixture which comprises aromatic isocyanates. Since aromatic isocyanates generally have a higher reactivity, gel times are shorter for such mixtures. Therefore, reaction mixtures comprising up to 20 wt.-% or up to 40 wt.-% or up to 60 wt.-% of aromatic polyisocyanates reach a viscosity 3 times higher than the starting viscosity within 90 minutes or less at handling temperature while still reaching the gel point within less than 20 minutes at elevated temperatures.

The above definition notwithstanding, it is particularly preferred that at handling temperature all reaction mixtures according to the present invention do not reach the gel point for at least one hour.

Preferably, the concentration of the dissolved catalyst in the polymerizable composition at polymerization temperature is between 0.0002 mol/kg and 0.20 mol/kg with respect to the overall weight of the polymerizable composition, i.e. the amount of dissolved catalyst is divided by the weight of the overall polymerizable composition.

In a preferred embodiment of the present invention, the concentration of the dissolved catalyst in the polymerizable composition is between 0.001 mol/kg and 0.10 mol/kg, more preferred between 0.003 mol/kg and 0.05 mol/kg and most preferred between 0.006 mol/kg and 0.02 mol/kg.

If the active catalyst is provided due to a melt process of the solid catalyst particles before or at the polymerization temperature the active catalyst concentration equals the amount of solid catalyst particles initially used. The preferred range of catalyst concentration in the polymerizable composition is same as described above for the dissolved catalyst.

If using a co-catalyst or a solvent system, the concentration of the dissolved catalyst can also be determined by using the concentration of the dissolved catalyst in the co-catalyst system or solvent at polymerization temperature and considering the amount of this mixture in the overall polymerizable composition. The preferred range of catalyst concentration in the polymerizable composition using the co-catalyst/solvent approach is same as described above for the dissolved catalyst.

The prior art describes thermal latent catalysts which are formulated as particles with a coating made of a catalytically inactive substance. Said coating melts, dissolves or becomes permeable for the catalyst at elevated temperatures, thus releasing the catalyst. This solution to the problem has the disadvantage that the coating of the catalyst particles becomes part of the reaction mixture. Depending on the composition of the coating this may negatively affect the properties of the polymer product. Moreover, development and synthesis of such coated catalyst particles with the appropriate set of properties to ensure a stable dispersion is a quite time-consuming, complicated and expensive task. The present invention has the advantage that such coatings are dispensable, thus enabling polymerizable compositions with a lower content of potentially deleterious additives and in an efficient and simple way. Consequently, it is preferred that the catalyst particles are not covered with any kind of coating which itself is catalytically inactive. It is particularly preferred that the catalyst particles consist of a metal salt as defined above.

Heating to the Polymerization Temperature

The term “polymerization temperature” refers to a temperature which is required for the crosslinking of the polyisocyanates comprised by the polymerizable composition. If a component reactive with isocyanate is present in the polymerizable composition, the polymerization temperature is also sufficient to induce the crosslinking of the isocyanate groups of the polyisocyanate or polyisocyanates with the reactive groups of said component. As the catalyst of the present invention is only active if it is present in liquid form, it is also required that the polymerization temperature is high enough that the catalyst is present as melt or in solution.

In a preferred embodiment of the present invention, a polymerization temperature is selected at which the polymerizable composition reaches its gel point within 20 minutes, preferably within 10 minutes and most preferably within 5 minutes. In a particular preferred embodiment the polymerizable composition becomes solid within the aforementioned time frame at the selected temperature.

The person skilled in the art knows that the reaction temperature required for the above-defined reaction speed depends on the type of polyisocyanate, as well as the type and concentration of catalyst. The optimization of the reaction temperature can easily be performed for a given system.

Preferably, a reaction temperature is chosen which leads to the consumption of at least 50%, preferably at least 75% and more preferably at least 90% of the isocyanate groups present at the beginning of method step b) within 60 minutes. A reaction temperature which enables the consumption of at least 75% of the isocyanate groups present at the beginning of method step b) within 20 minutes is particularly preferred. Given the fact that the catalyst must dissolve or melt, the temperature during method step b) will be typically at least 60° C., preferably at least 80° C., more preferably at least 100° C. and most preferably at least 130° C. An absolute upper limit of the temperature is defined by the thermal stability of the polyisocyanate and the resulting polymer. This temperature is 280° C.

Depending on the type of catalyst used and the composition of the polymerizable composition method step b) results in different polymer materials. If the polymerizable composition is characterized by a high ratio of isocyanate groups to functional groups reactive with isocyanate groups, the polymer will comprise a high proportion of isocyanurate groups. On the other hand, if said ratio is lower, the proportion of isocyanurate groups will decrease and the proportion of urethane, urea and thiourethane groups will increase.

The present invention is particularly suited for the manufacture of fiber-reinforced materials because the polymerizable composition has a long pot life at low temperatures and cures rapidly at the elevation temperature. These properties are particularly useful in the pultrusion process for manufacturing fiber-reinforced polymer materials. Hence, in a preferred embodiment of the present invention a fiber is contacted with the polymerizable composition provided in method step a) before performing method step b).

Use

In a further embodiment the present invention relates to the use of a catalyst comprising at least one metal salt, wherein the metal is selected from the group consisting of potassium, lithium, sodium, calcium, tin and barium and wherein said metal salt is solid below a temperature of 50° C. and is liquid at the polymerization temperature for the crosslinking of isocyanate groups.

All definitions given above also apply to this embodiment.

In a first item, the present invention relates to a method for producing a polymer comprising the steps of
a) providing a polymerizable composition comprising
   (i) a liquid phase comprising at least one polyisocyanate,
   (ii) a solid phase comprising at least one catalyst comprising a metal salt having a carboxylate, phenolate or carbonate as the anion capable of crosslinking the polyisocyanate so that a polymer is formed, wherein said catalyst is solid below a temperature of 50° C. and is liquid or dissolved at a polymerization temperature of 60° C. to 280° C., and
b) heating the polymerizable composition to the polymerization temperature and maintaining said temperature at least until the polymerizable composition reaches the gel point.
In a second item the present invention relates to the method of item 1, wherein the catalyst is present in particles with number average diameter of 100 nm to 100 μm.
In a third item the present invention relates to the method of item 1 or 2, wherein the anion of the salt is a carboxylate.
In a fourth item the present invention relates to the method of item 3, wherein the carboxylate is derived from a carboxylic acid with at least 12 carbon atoms.
In a fifth item the present invention relates to the method of item 4, wherein the carboxylate is selected from the group consisting of laureate, myristate, palmitate, stearate and dimeric acids.
In a sixth item the present invention relates to the method of any one of items 1 to 5, wherein the metal is selected from the group consisting of potassium, lithium, sodium, calcium and barium.
In a seventh item the present invention relates to the method of any one of items 1 to 6, wherein the polyisocyanate is selected from the group consisting of PDI, HDI, IPDI, H12MDI, TDI, MDI, XDI, TMXDI and oligomeric polyisocyanates formed from the aforementioned diisocyanates.
In an eighth item the present invention relates to the method of any one of items 1 to 7, wherein the metal salt is suspended in a polyethylene glycol derivative having at least three consecutive ethylene oxide units.
In a ninth item the present invention relates to the method of any one of items 1 to 8, wherein the molar ratio of isocyanate groups to all functional groups reactive with isocyanate in the polymerizable composition is at least 3.0:1.0.
In a tenth item the present invention relates to the method of item 9 wherein the metal is potassium.
In an eleventh item the present invention relates to the method of any one of items 1 to 8, wherein the molar ratio of isocyanate groups to all functional groups reactive with isocyanate in the polymerizable composition is at least 0.5:1.0 and below 3.0:1.0.
In a twelfth item the present invention relates to the method of any of the items 1 to 11, wherein the polymerizable composition reaches at handling temperatures within 3 hours after mixing less than 3 times of the starting viscosity, and reaches at polymerization temperature the gel point within 20 min or less.
In a thirteenth item the present invention relates to the method of item 11, wherein at least 80 mol-% of all groups reactive with isocyanate in the polymerizable composition belong to at least one polyol selected from the group consisting of 1,2,10-decanetriol, 1,2,8-octanetriol, 1,2,3-trihydroxybenzene, glycerol, 1,1,1-trimethylolpropane, 1,1,1-trimethylolethane, pentaerythritol and sugar alcohols.
In a fourteenth item the present invention relates to the method of any one of items 1 to 13, wherein a fiber is contacted with the polymerizable composition provided in method step a) before performing method step b).
In a fifteenth item the present invention relates to the use of a catalyst comprising at least one metal salt, wherein the metal is selected from the group consisting of potassium, lithium, sodium, calcium and barium and wherein said metal salt is solid below a temperature of 50° C. and is liquid at the polymerization temperature for the crosslinking of isocyanate groups.

The examples given below are only intended to illustrate the present invention. They shall not limit the scope of the claims in any way.

### EXAMPLES

Experiment Information:

The currently prevailing ambient temperature of 25° C. is described as RT in experimental part.

The NCO functionality of the various raw materials was determined from the respective data sheet of the raw materials.

Raw Material:

Desmodur® N 3600 is a hexamethylene diisocyanate (HDI) trimer (NCO functionality >3) with 23.0 wt.-% NCO content, the viscosity is about 1200 mPas at 23° C. (DIN EN ISO 3219/A.3), from Covestro AG.

Desmodur® N 3900 is a HDI trimer (NCO functionality >3) with 23.5 wt.-% NCO content, the viscosity is about 730 mPas at 23° C. (DIN EN ISO 3219/A.3), from Covestro AG.

Desmodur® XP 2489 is a HDI isophorone diisocyanate (IPDI) polyisocyanate (NCO functionality >3) with 21.0 wt.-% NCO content, the viscosity is about 22500 mPas at 23° C. (DIN EN ISO 3219/A.3), from Covestro AG.

Desmodur® eco N 7300 is a biobased pentamethylene diisocyanate (PDI) trimer (NCO functionality >3) with 21.9 wt.-% NCO content, the viscosity is about 9500 mPas at 23° C. (DIN EN ISO 3219/A.3), from Covestro AG.

Desmodur® W is a monomeric dicyclohexylmethane 4,4′-diisocyanate (H₁₂MDI) (NCO functionality is 2) with 31.8 wt.-% NCO content, the viscosity is about 30 mPas at 23° C. (DIN EN ISO 3219/A.3), from Covestro AG.

Desmodur® N 3300 is a hexamethylene diisocyanate (HDI) trimer (NCO functionality >3) with 21.8 wt.-% NCO content, the viscosity is about 3000 mPas at 23° C. (DIN EN ISO 3219/A.3), from Covestro AG.

Desmodur® 3133 is a mixture of modified diphenylmethane-4,4′-diisocyanate (MDI) with isomers and homologues of higher functionality with 32.5 wt.-% NCO content, the viscosity is about 25 mPas at 23° C. (DIN EN ISO 3219/A.3), from Covestro AG.

PEG 400 is polyethylene glycol with a number average molecular weight Mn of 400 and a purity of 99.5 wt.-% from Sinopharm Chemical Reagent Co., Ltd.

PEG 200 is polyethylene glycol with a number average molecular weight Mn of 200 and a purity of 99.5 wt.-% from Sinopharm Chemical Reagent Co., Ltd.

DEG is diethylene glycol with a purity 98.0 wt.-% from Sinopharm Chemical Reagent Co., Ltd.

Potassium stearate was purchased with a purity >98.0 wt.-% from Macklin Inc.

Potassium acetate was purchased with a purity 92.0 wt.-% from Sinopharm Chemical Reagent Co., Ltd.

Potassium oleate was purchased with a purity 99.5 wt.-% from Sinopharm Chemical Reagent Co., Ltd.

Potassium 2-ethylhexanoate was purchased with a purity >95 wt.-% from TCI Co., Ltd.

Potassium laurate was purchased with a purity >95 wt.-% from Micxy reagent Co., Ltd.

Potassium palmitate was purchased with a purity >95 wt.-% from Spectrum Chemical Mfg. Corp.

Hydrogenated dimer acid was purchased from Tianjin Heowns Biochemical Technology Co., Ltd.

Glycerol was purchased with a purity 99.0 wt.-% from Sinopharm Chemical Reagent Co., Ltd.

DBTL is dibutyltin dilaurate and was purchased with a purity >95 wt.-% from TCI Co., Ltd.

Determining the Brookfield Viscosity:

The viscosity of a small amount of reactive resin material including the catalyst was determined according to DIN EN ISO 3219 by Brookfield DV-II+ Pro viscometer. The viscosity of fresh polyisocyanate composition with catalyst was measured immediately after mixing by SpeedMixer at RT (starting viscosity). The time interval between the test time and the end time of mixing was not more than 15 min. The latency of this mixture was monitored by measuring the viscosity of the resin material after storage at 50° C. for 3 hours in a sealed container. The viscosity was tested at the temperature of mixture (50° C.) without cooling down to RT.

Determining the Tg Value by DSC:

The glass transition temperature (Tg) of the cured resins was determined by differential scanning calorimetry (DSC) on a TA DSC Q20 according to DIN EN 61006. Pure indium was used as standard for calorimetric calibration. Runs were carried out using empty standard hermetic pans as a reference. About 10 mg resin sample was accurately weighted and capsuled in aluminum hermetic pan for test. The measurement was carried out by heating at a heating rate of −20° C. to 200° C. with 20° C./min heating rate, followed by cooling at a cooling rate of 20° C./min. Nitrogen was used as purge gas. The values in Table 1 were based on the evaluation of 1^{st} cycle of heating curve. The Tg was taken as the half-height of the corresponding glass transition stage.

Synthesis of dimer acid potassium salt Hydrogenated dimer acid (55.6 g) was added into water (130.0 g). The beaker was immersed into an oil bath, heated to a temperature between 70 and 80° C., and the mixture was stirred with an IKA stirrer with the speed of 300 rpm. After 15 min, 42.8 wt % KOH aqueous solution (25.5 g; COOH:OH=1:1) was added slowly dropwise to the dimer acid solution. The more KOH solution was added, the more of a white precipitation was obtained. After all potassium hydroxide was added, the mixture was stirred for another 15 min to form a white gel. The white gel was dried in an oven at 80° C. A white solid powder was obtained. The yield was quantitative.

Determining the Solubility of the Catalyst Salts:

A simple determination of the solubility of catalyst salts depending on different temperatures is shown in the following example: The catalyst salt (e.g. potassium stearate) and the solvent (e.g. PEG 400) were accurately weighted to prepare dispersions with 9 different concentrations including 0.01, 0.02, 0.05, 1.0, 2.0, 5.0, 10.0, 15.0 and 20.0 wt.-% salt in solvent. Then, the dispersions were stirred at 3 different temperatures: R.T., 50° C., and polymerization temperature (e.g. 180° C.) for 8 hours and checked carefully if there were any solids left in the solution. The highest concentration of the solutions with no residual solids left was defined as the solubility at this corresponding temperature. Following this procedure the solubility of potassium stearate in PEG 400 (polyethylene glycol with molecule weight of 400) at room temperature is 0.02 wt.-%; at 50° C. it is 1.0 wt % and at 180° C. it is 5.0 wt %.

Dimer acid potassium also shows similar characterization as potassium stearate. The solubility of dimer acid potassium in PEG 400 at room temperature is 1.0 wt.-% and at 180° C. is 10.0 wt.-%.

Determining the Particle Size of the Carboxylic Acid Salts:

The particle size of the solid catalyst was determined by using a particle analyzer Zetasizer Nano ZS 3600 from Fa. Malvern at room temperature. The solid catalyst particles were suspended in PEG 400 at room temperature according to the general procedure for catalyst preparation (Method A) and then stepwise diluted until the measurement could be conducted. The average particle size of the solid catalyst was determined for potassium stearate (534 nm; STD 140 nm), potassium laurate (474 nm; STD 274 nm) and potassium palmitate (bimodal; 467 nm, STD 110 nm; 5260 nm, STD 437 nm).

General Procedure for Catalyst Preparation:

Method a (Catalyst-Suspension)

The following example is a typical method for preparing a catalyst system based on suspensions with potassium stearate in PEG 400 or DEG:

Potassium stearate (5.0 g) was mixed with PEG 400 (95.0 g). The final concentration of potassium stearate was 5 wt.-%. This mixture was mechanically stirred at RT for 10-30 min until most of the potassium salt was well dispersed. This fine suspension of powdered potassium salt in liquid PEG 400 was used as catalyst without further treatment.

10 wt.-%, 20 wt.-%, and 30 wt.-% suspensions of potassium stearate in PEG 400, 20 wt.-% suspension of potassium stearate in DEG, 20 wt.-% suspension of potassium palmitate in PEG 400, 11 wt.-% suspension of potassium laurate in PEG 400, and 5 wt.-% and 30 wt.-% suspensions of dimer acid potassium in PEG 400 were prepared exactly as in the aforementioned process except that the final concentration of potassium salts and the type of solvent were adjusted.

Method B (Catalyst-Solution)

The following example is a typical method for preparing a catalyst system of clear and homogeneous potassium salt solutions:

Potassium Acetate (5.0 g) was mixed with PEG 400 (95.0 g). The final concentration of potassium acetate was 5 wt.-%. The mixture was mechanically stirred at RT until all potassium salt was completely dissolved. A clear and homogeneous solution was obtained and used as catalyst without further treatment.

5 wt.-% solution of potassium 2-ethylhexanoate in PEG 400, 5 wt.-% solution of potassium oleate in PEG 400 and 15 wt.-% solution of potassium oleate in PEG 400 were prepared exactly as in the aforementioned process except that the type of potassium salt, solvent and concentration of potassium salt were adjusted.

General Procedure for Polyisocyanurates Sample Preparation:

The isocyanate components and aforementioned catalyst were carefully weighed in a FlackTek mixing cup and mixed at 2500 rpm for at 60-180 seconds using a SpeedMixer DAC 400 FV. The latency (i.e. viscosity change at 50° C.) of one set of samples was observed and recorded in Table 1. The other set of duplicate samples (10 g of each sample) were heated at a heating platform to 180° C. Periodic observations were made until the polyisocyanurate resin was firm and non-tacky, and the time was recorded.

### Example 1

As described above, a 5 wt.-% suspension of potassium stearate in PEG 400 was obtained and used as catalyst. Desmodur® N 3600 (91.5 g) and catalyst suspension (4.5 g) were mixed by SpeedMixer. 10 g of the mixture were subsequently put into a mold (metal lid, about 6 cm in diameter and about 1 cm high) followed by heating on the heating platform of an IKA RCT stirrer with the setting temperature at 180° C. The cure time was recorded until the resin was firm and non-tacky. The resin was separated from the mold after curing and 10 mg of the resin were used for measuring Tg by DSC. The viscosity of freshly-made resin mixture was measured within 15 min after mixing and checked again after storage at 50° C. oven for 3 hours in a closed container. The results are shown in table 1.

### Example 2

As described above, a 10 wt % suspension of potassium stearate in PEG 400 was obtained and used as catalyst. Desmodur® N 3600 (91.5 g) and catalyst suspension (4.5 g) were mixed by SpeedMixer. The experiment was conducted in the same way as example 1 and the curing time, Tg and viscosity were recorded. The results are shown in table 1.

### Example 3

As described above, a 15 wt.-% suspension of potassium stearate in PEG 400 was obtained and used as catalyst. Desmodur® N 3600 (91.5 g) and catalyst suspension (4.5 g) were mixed by SpeedMixer. The experiment was conducted in the same way as example 1 and the curing time, Tg and viscosity were recorded. The results are shown in table 1.

### Example 4

As described above, a 20 wt.-% suspension of potassium stearate in PEG 400 was obtained and used as catalyst. Desmodur® N 3600 (91.5 g) and catalyst suspension (4.5 g) were mixed by SpeedMixer. The experiment was conducted in the same way as example 1 and the curing time, Tg and viscosity were recorded. The results are shown in table 1.

### Example 5

As described above, a 30 wt.-% suspension of potassium stearate in PEG 400 was obtained and used as catalyst. Desmodur® N 3600 (91.5 g) and catalyst suspension (4.5 g) were mixed by SpeedMixer. The experiment was conducted in the same way as example 1 and the curing time, Tg and viscosity were recorded. The results are shown in table 1.

### Example 6

As described above, a 20 wt.-% suspension of potassium stearate in PEG 400 was obtained and used as catalyst. Desmodur® N 3900 (95.0 g) and catalyst suspension (5.0 g) were mixed by SpeedMixer. The experiment was conducted in the same way as example 1 and the curing time, Tg and viscosity were recorded. The results are shown in table 1.

### Example 7

As described above, a 20 wt.-% suspension of potassium stearate in DEG was obtained and used as catalyst. Desmodur® N 3600 (93.5 g) and catalyst suspension (4.0 g) were mixed by SpeedMixer. The experiment was conducted in the same way as example 1 and the curing time, Tg and viscosity were recorded. The results are shown in table 1.

### Example 8

As described above, a 10 wt.-% suspension of potassium stearate in PEG 400 was obtained and used as catalyst. Desmodur® XP 2489 (93.5 g) and catalyst suspension (4.0 g) were mixed by SpeedMixer. The experiment was conducted in the same way as example 1 and the curing time, Tg and viscosity were recorded. The results are shown in table 1.

### Example 9

As described above, a 15 wt.-% suspension of potassium stearate in PEG 400 was obtained and used as catalyst. Desmodur® eco N 7300 (95.0 g) and catalyst suspension (5.0 g) were mixed by ixer. The experiment was conducted in the same way as example 1 and the curing time, Tg and viscosity were recorded. The results are shown in table 1.

### Example 10

As described above, a 20 wt.-% suspension of potassium stearate in PEG 400 was obtained and used as catalyst. Desmodur® N 3600 (45.0 g), Desmodur® W (45.0 g) and catalyst suspension (4.0 g) were mixed by SpeedMixer. The experiment was conducted in the same way as example 1 and the curing time, Tg and viscosity were recorded. The results are shown in table 1.

### Example 11

As described above, a 20 wt.-% suspension of potassium palmitate in PEG 400 was obtained and used as catalyst. Desmodur® N 3600 (91.5 g) and catalyst suspension (4.5 g) were mixed by SpeedMixer. The experiment was conducted in the same way as example 1 and the curing time, Tg and viscosity were recorded. The results are shown in table 1.

### Example 12

As described above, a 11 wt.-% suspension of potassium laurate in PEG 400 was obtained and used as catalyst. Desmodur® N 3600 (91.5 g) and catalyst suspension (4.5 g) were mixed by SpeedMixer. The experiment was conducted in the same way as example 1 and the curing time, Tg and viscosity were recorded. The results are shown in table 1.

### Example 13

As described above, a 5 wt.-% suspension of dimer acid potassium in PEG 400 was obtained and used as catalyst. Desmodur® N 3600 (93.5 g) and catalyst suspension (4.0 g) were mixed by SpeedMixer. The experiment was conducted in the same way as example 1 and the curing time, Tg and viscosity were recorded. The results are shown in table 1.

### Example 14

As described above, a 30 wt.-% suspension of dimer acid potassium in PEG 400 was obtained and used as catalyst. Desmodur® N 3600 (93.5 g) and catalyst suspension (4.0 g) were mixed by SpeedMixer. The experiment was conducted in the same way as example 1 and the curing time, Tg and viscosity were recorded. The results are shown in table 1.

### Example 15

As described above, 5 wt.-% suspension of potassium stearate in PEG 400 was obtained and used as catalyst. Desmodur® N 3600 (119.0 g), Glycerol (20.0 g) and catalyst suspension (4.5 g) were mixed by SpeedMixer. The experiment was conducted in the same way as example 1 and the curing time, Tg and viscosity were recorded. The results are shown in table 2.

### Example 16

40 g Desmodur® N 3300 were premixed with 1.8 g 10 wt.-% potassium stearate in DEG and then mixed with 60 g Desmodur® 3133. At 180 degree the curing time was less than 2 minutes while the gel time at room temperature was 100 minutes. When 10 wt.-% potassium stearate in DEG were replaced by 10 wt.-% potassium acetate in DEG, the reaction mixture reached the gel point almost immediately.

### Comparative Example 1

As described above, a 5 wt.-% clear and homogeneous solution of potassium acetate in PEG 400 was obtained and used as catalyst. Desmodur® N 3600 (91.5 g) and catalyst solution (4.5 g) were mixed by SpeedMixer. The experiment was conducted in the same way as example 1 and the curing time, Tg and viscosity were recorded. After storage at 50° C. in an oven for 3 hours, the reaction mixture solidified to form a white gel, the viscosity value could not be measured anymore. The results are shown in table 1.

### Comparative Example 2

As described above, a 5 wt.-% clear and homogeneous solution of potassium oleate in PEG 400 was obtained and used as catalyst. Desmodur® N 3600 (91.5 g) and catalyst solution (4.5 g) were mixed by SpeedMixer. The experiment was conducted in the same way as example 1 and the curing time, Tg and viscosity were recorded. The results are shown in table 1.

### Comparative Example 3

As described above, a 5 wt % clear and homogeneous solution of potassium 2-ethylhexanoate in PEG 400 was obtained and used as catalyst. Desmodur® N 3600 (91.5 g) and catalyst solution (4.5 g) were mixed by SpeedMixer. The experiment was conducted in the same way as example 1 and the curing time, Tg and viscosity were recorded. After storage at 50° C. in an oven for 3 hours, the reaction mixture solidified to form a white gel, the viscosity value could not be measured anymore. The results are shown in table 1.

### Comparative Example 4

As described above, a 15 wt % clear and homogeneous solution of potassium oleate in PEG 400 was obtained and used as catalyst. Desmodur® N 3600 (91.5 g) and catalyst solution (4.5 g) were mixed by SpeedMixer. The experiment was conducted in the same way as example 1 and the curing time, Tg and viscosity were recorded. The results are shown in table 1.

### Comparative Example 5

Desmodur® N 3600 (119.0 g) and Glycerol (20.0 g) without catalyst were mixed by SpeedMixer. The experiment was conducted in the same way as example 1 and the curing time, Tg and viscosity were recorded. The results are shown in table 2.

### Comparative Example 6

Desmodur N 3600 (119.0 g), Glycerol (20.0 g) and DBTL (11.9 mg) were mixed by SpeedMixer. The experiment was conducted in the same way as example 1 and the curing time, Tg and viscosity were recorded. The results are shown in table 2.

TABLE 1

| | | | | | | Viscosity of | | |
|---|---|---|---|---|---|---|---|---|
| | | | | Viscosity after | | mixture after | | |
| | | | Curing Time | mixing within | | storage at 50° C. | | |
| Example No. | Polyisocyanate | Catalyst Compositon | at 180° C. | 15 min at RT | | for 3 hours | | Tg |
| Example 1 | Desmodur ® N 3600 | 5 wt % Potassium Stearate in | <5 min | 812 | mPa · s | 1428 | mPa · s | 104° C. |
| | | PEG 400 | (50″-1′50″) | | | | | |
| Example 2 | Desmodur ® N 3600 | 10 wt % Potassium Stearate in | <5 min | 895 | mPa · s | 1080 | mPa · s | 104° C. |
| | | PEG 400 | (1′02″-2′05″) | | | | | |
| Example 3 | Desmodur ® N 3600 | 15 wt % Potassium Stearate in | <5 min | 860 | mPa · s | 1548 | mPa · s | 105° C. |
| | | PEG 400 | (59″-2′05″) | | | | | |
| Example 4 | Desmodur ® N 3600 | 20 wt % Potassium Stearate in | <5 min | 852 | mPa · s | 1170 | mPa · s | 105° C. |
| | | PEG 400 | (59″-2′00″) | | | | | |
| Example 5 | Desmodur ® N 3600 | 30 wt % Potassium Stearate in | <5 min | 980 | mPa · s | 1108 | mPa · s | 106° C. |
| | | PEG 400 | (1′17″-2′05″) | | | | | |
| Example 6 | Desmodur ® N 3900 | 20 wt % Potassium Stearate in | <5 min | 660 | mPa · s | 898 | mPa · s | 80° C. |
| | | PEG 400 | (1′30″-3′00″) | | | | | |
| Example 7 | Desmodur ® N 3600 | 20 wt % Potassium Stearate in | <5 min | 820 | mPa · s | 1543 | mPa · s | 110° C. |
| | | DEG | (1′14″-1′50″) | | | | | |
| Example 8 | Desmodur ® XP 2489 | 10 wt % Potassium Stearate in | <5 min | 9000 | mPa · s | 16500 | mPa · s | 129° C. |
| | | PEG 400 | (1′22″-2′25″) | | | | | |
| Example 9 | Desmodur ® eco N | 15 wt % Potassium Stearate in | <5 min | 6520 | mPa · s | 7800 | mPa · s | 132° C. |
| | 7300 | PEG 400 | (1′15″-1′45″) | | | | | |
| Example10 | Desmodur ® N 3600 | 20 wt % Potassium Stearate in | <5 min | 180 | mPa · s | 230 | mPa · s | 129° C. |
| | Desmodur ® W (1:1) | PEG 400 | (1′36″-2′30″) | | | | | |
| Example 11 | Desmodur ® N 3600 | 20 wt % Potassium Palmitate in | <5 min | 1400 | mPa · s | 2470 | mPa · s | 103° C. |
| | | PEG 400 | (1′13″-2′10″) | | | | | |
| Example 12 | Desmodur ® N3600 | 11 wt % Potassium Laurate in | <5 min | 1900 | mPa · s | 3600 | mPa · s | 105° C. |
| | | PEG 400 | (1′10″-1′50″) | | | | | |
| Example 13 | Desmodur ® N 3600 | 5 wt % Dimer acid potassium in | <5 min | 790 | mPa · s | 1528 | mPa · s | 112° C. |
| | | PEG 400 | (2′30″-4′19″) | | | | | |
| Example 14 | Desmodur ® N 3600 | 30 wt % Dimer acid potassium in | <5 min | 1380 | mPa · s | 1624 | mPa · s | 115° C. |
| | | PEG 400 | (2′30″-3′47″) | | | | | |
| Comparative | Desmodur ® N 3600 | 5 wt % Potassium Acetate in | <5 min | 904 | mPa · s | gel | | 103° C. |
| Example 1 | | PEG 400 | (1′03″-2′10″) | | | | | |
| Comparative | Desmodur ® N 3600 | 5 wt % Potassium Oleate in | <5 min | 952 | mPa · s | 6300 | mPa · s | 103° C. |
| Example 2 | | PEG 400 | (1′17″-2′10″) | | | | | |
| Comparative | Desmodur ® N 3600 | 5 wt % Potassium 2- | <5 min | 1330 | mPa · s | gel | | 105° C. |
| Example 3 | | ethylhexanoate in PEG 400 | (50″-1′45″) | | | | | |
| Comparative | Desmodur ® N 3600 | 15 wt % Potassium Oleate in | <5 min | 874 | mPa · s | 9378 | mPa · s | 104° C. |
| Example 4 | | PEG 400 | (1′10″-2′15″) | | | | | |

The experiments show that the polyisocyanurate compositions of examples 1 to 7 had a rapid cure behavior at higher curing temperature with curing time less than 5 min, meanwhile with higher Tg. This curing behavior is comparable with the systems of Comparative Example 1 to 4 which were catalyzed by homogenous solutions of conventional potassium carboxylates salts. Meanwhile the example 1 to 7 showed better storage stability at accelerated aging condition than comparative examples 1 to 4. The viscosity of the examples 1 to 7 after storage at elevated temperature for 3 hours had not doubled, and kept close to 1000 mPa·s which is the optimum viscosity range for the practical operation and impregnation of the fibers in composite applications. Examples 1-7 show that the catalyst concentration used at room or at the elevated temperature will not obviously affect the viscosity change, which is supporting the assumption that no or only little amounts of catalyst are available at low temperature. On the other hand, at higher (curing) temperature the catalyst becomes available. This characteristic of the systems allows for high catalyst loadings without sacrificing pot-life.

As shown in Table 2, this latent reactive catalyst system can also be applied for polyurethane formation. The viscosity change of example 15 is comparable to Comparative example 5 without any catalyst inside, but the curing rate is faster than the system without catalyst. Comparative example 6 shows that traditional tin catalyst-DBTL will cause fast curing but with very short pot life.

TABLE 2

| | | | | | Viscosity of | |
|---|---|---|---|---|---|---|
| | | | | Viscosity after | mixture after | |
| | Polyisocyanate + | | Curing Time | mixing within | storage at 50° C. | |
| Example No. | Polyol | Catalyst Compositon | at 180° C. | 15 min at RT | for 3 hours | Tg |
| Example 15 | Desmodur ® N | 5 wt % Potassium Stearate in | <5 min | 1548 mPa · s | 421 mPa · s | 75° C. |
| | 3600 + Glycerol | PEG 400 | (2′40″-3′50″) | | | |
| Comparative | Desmodur ® N | No Catalyst | >10 min | 1548 mPa · s | 438 mPa · s | 53° C. |
| Example 5 | 3600 + Glycerol | | (15′00″-20′00″) | | | |
| Comparative | Desmodur ® N | DBTL | <5 min | 1428 mPa · s | gel | 98° C. |
| Example 6 | 3600 + Glycerol | | (1′20″-2′00″) | | | |

Due to the aforementioned prolonged storage stability and the rapid curing, the reaction mixtures disclosed in this invention are very suitable for practical and efficient manufacturing of fiber reinforced polyisocyanurate and polyurethane composites with the possibility of omitting the use of expensive metering apparatus.

1. A method for producing a polymer comprising:
a) providing a polymerizable composition having a molar ratio of isocyanate groups to all functional groups reactive with isocyanate in the polymerizable composition of at least 3.0:1.0 comprising
(i) a liquid phase comprising at least one polyisocyanate,
(ii) a solid phase comprising at least one catalyst comprising a metal salt having a carboxylate of an aliphatic carboxylic acid comprising at least 12 carbon atoms or a phenolate as an anion capable of crosslinking the polyisocyanate so that a polymer is formed, wherein said catalyst is solid below a temperature of 50° C. and is liquid or dissolved at a polymerization temperature of 60° C. to 280° C., and
b) heating the polymerizable composition to the polymerization temperature and maintaining said temperature at least until the polymerizable composition reaches the gel point.

2. The method of claim 1, wherein the catalyst is present as particles having a number average diameter of 100 nm to 100 μm.

3. The method of claim 1, wherein the anion of the salt is a carboxylate.

4. The method of claim 3, wherein the carboxylate is derived from a carboxylic acid with at least 12 carbon atoms.

5. The method of claim 4, wherein the carboxylate is selected from the group consisting of: laureate, myristate, palmitate, stearate, and dimeric acids.

6. The method of claim 1, wherein the metal is selected from the group consisting of: potassium, lithium, sodium, calcium, and barium.

7. The method of claim 6, wherein the metal is potassium.

8. The method of claim 1, wherein the polyisocyanate is selected from the group consisting of: PDI, HDI, IPDI, H12MDI, TDI, MDI, XDI, TMXDI, and oligomeric polyisocyanates formed from the aforementioned diisocyanates.

9. The method of claim 1, wherein at least 40 wt. % of all polyisocyanates of the polymerizable composition are monomeric and/or oligomeric aliphatic polyisocyanates.

10. The method of claim 1, wherein the polymerizable composition comprises up to 60 wt.-% of at least one aromatic polyisocyanate.

11. The method of claim 1, wherein the metal salt is suspended in a polyethylene glycol derivative having at least three consecutive ethylene oxide units.

12. The method of claim 1, wherein the polymerizable composition reaches a viscosity less than 3 times a starting viscosity at handling temperatures within 90 minutes after mixing, and reaches the gel point within 20 min or less at the polymerization temperature.

13. The method of claim 1, further comprising contacting a fiber with the polymerizable composition provided in method step a) before performing method step b).

14. A method of crosslinking isocyanate groups, comprising catalyzing isocyanate crosslinking with a catalyst comprising at least one metal salt, wherein the metal is selected from the group consisting of potassium, lithium, sodium, calcium, and barium and wherein said metal salt is solid below a temperature of 50° C. and is liquid at a polymerization temperature.
